(19) United States
(12) Patent Application Publication
(10) Pub. No.: US 2011/0035099 A1
(43) Pub. Date: Feb. 10, 2011

(54) Display control device, display control method and computer program product for the same

(75) Inventor: Kenji Kobayashi, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/805,422

(22) Filed: Jul. 30, 2010

(30) Foreign Application Priority Data
Aug. 4, 2009 (JP) 2009-181557

(51) Int. Cl. G06F 7/00; G09G 5/10

(52) U.S. Cl. 701/36; 345/690

(57) ABSTRACT

In a display control device, a direction of a light source in a region around a self-vehicle is estimated, and whether the direction of the light source coincides with a display arrangement direction which indicates an arrangement direction of a display portion as viewed from a passenger in the self-vehicle is determined. Then, a brightness of the display portion is set to be increased when the direction of the light source coincides with the display arrangement direction, compared with when the direction of the light source does not coincide with the display arrangement direction. Therefore, the brightness of the display portion can be more accurately controlled such that the display portion is easily viewed by the passenger in the self-vehicle.

### CROSS REFERENCE TO RELATED APPLICATION

The present application is based on Japanese Patent Application No. 2009-181557 filed on Aug. 4, 2009, the disclosure of which is incorporated herein by reference.

### FIELD OF THE INVENTION

The present invention relates to a display control device, a display control method and a computer program product for displaying an image on a display portion mounted to a vehicle.

### BACKGROUND OF THE INVENTION

As the above-described display control device, a technology for adjusting a brightness (also referred to as a degree of brightness), or a luminance of a display portion in accordance with brightness in front of a vehicle is known (for example, refer to JP-A-2007-050757). In the technology, in order that a passenger in the vehicle may easily view the display portion, the brightness of the display portion is set to be brightened when the front of the vehicle is bright and the brightness of the display portion is set to be darkened when the front of the vehicle is dark.

However, in the above-described display control device, the brightness of the display portion is adjusted based on absolute brightness in front of the vehicle. Thus, in the case where a light source, although not having absolute brightness, which the passenger in the vehicle senses relatively bright exists because of surrounding darkness (for example, in the case where a headlight of an oncoming vehicle exists in front of the vehicle during nighttime), the brightness of the display portion may not be set to be brightened. In this case, the passenger may sense that the brightness of the display portion is insufficiently.

### SUMMARY OF THE INVENTION

In view of the above-described difficulty, it is an object of the present invention to provide a display control device, a display control method and a computer program product for displaying an image on a display portion mounted to a vehicle, in which a brightness of the display portion can be accurately controlled such that the display portion is easily viewed by a passenger in the vehicle.

According to a first aspect of the present invention, a display control device configured to display an image on a display portion mounted to a vehicle, comprises: a light-source direction estimating means for estimating a direction of a light source in a region around the vehicle; a direction-coincidence determining means for determining whether the direction of the light source coincides with a display arrangement direction, which indicates an arrangement direction of the display portion as viewed from a passenger in the vehicle; and a first brightness setting means for setting a brightness of the display portion to be increased when the direction of the light source coincides with the display arrangement direction, compared with when the direction of the light source does not coincide with the display arrangement direction.

According to a second aspect of the present invention, a display control method for displaying an image on a display portion mounted to a vehicle, comprises: estimating a direction of a light source in a region around the vehicle; determining whether the direction of the light source coincides with a display arrangement direction, which indicates an arrangement direction of the display portion as viewed from a passenger in the vehicle; and setting a brightness of the display portion to be increased when the direction of the light source coincides with the display arrangement direction, compared with when the direction of the light source does not coincide with the display arrangement direction.

Furthermore, according to the present invention, a computer program product stored in a computer readable storage medium comprises instructions that cause a computer to perform the method.

In the present invention, the direction of the light source, in other words, a direction toward a relatively bright area in the region around the vehicle, is detected, and the brightness of the display portion is set to be increased when the direction of the light source coincides with the direction toward which the passenger in the vehicle turns when viewing the display portion.

Accordingly, the brightness of the display portion can be set based on a position of the light source which the passenger in the vehicle senses relatively bright. Thus, compared with the configuration in which the brightness of the display portion is set based on the absolute surrounding brightness, the brightness of the display portion can be set to better correspond to a characteristic of human eyes. Therefore, the brightness of the display portion can be more accurately controlled such that the display portion is easily viewed by the passenger in the vehicle.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a configuration of a display control system according to an embodiment of the present invention;

FIG. 2 is an explanatory diagram showing arrangement of a camera and a display device according to the embodiment of the present invention;

FIG. 3 is a flow diagram showing a brightness setting process according to the embodiment of the present invention; and

FIGS. 4A to 4C are explanatory diagrams showing arrangement of a camera and a display device according to modified examples of the embodiment of the present invention.

### DETAILED DESCRIPTION OF THE PREFERRED EMBODIMENTS

Hereinafter, embodiments of the present invention will be described with reference to drawings.

### Embodiment

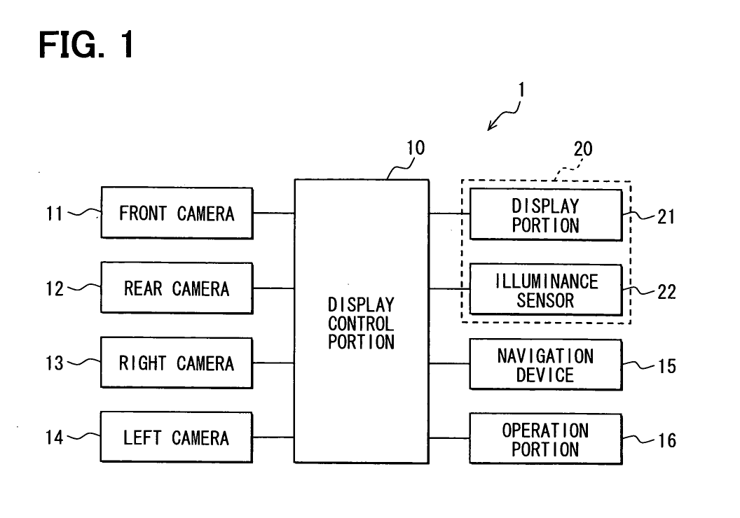

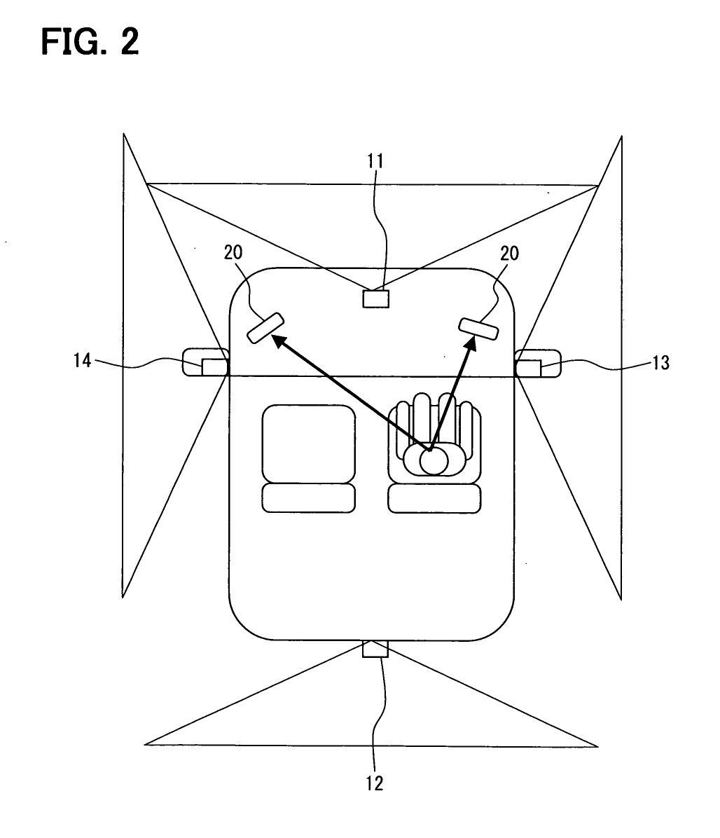

FIG. 1 is a block diagram showing a configuration of a display control system (display control device) 1 of the present invention. FIG. 2 is an explanatory diagram showing arrangement of cameras 11 to 14 and a display device 20.

The display control system 1 is, mounted to a vehicle such as a passenger vehicle. The display control system 1 is a system that adjusts a display brightness of the display device 20 mounted to the vehicle and displays an image on the display device 20. In addition, in the following explanation, the vehicle to which the display control system 1 is mounted is also referred to as a self-vehicle.

In particular, as shown in FIG. 1, the display control system 1 includes a display control portion 10, various cameras 11 to 14, the display device 20, a navigation device 15, and an operation portion 16.

The cameras 11 to 14 include a front camera 11, a rear camera 12, a right camera 13, and a left camera 14. Each of the cameras 11 to 14 is configured as a CMOS camera or a CCD camera, which is commonly-known, for example. The cameras 11 to 14 send captured images to the display control portion 10.

As shown in FIG. 2, the front camera 11 is placed on the center of a front side of the self-vehicle such that the front side of the self-vehicle is set to be within an image-capturing range. The rear camera 12 is placed on the center of a rear side of the self-vehicle such that the rear side of the self-vehicle is set to be within the image-capturing range.

The right camera 13 is placed on a right side mirror such that a right side of the self-vehicle is set to be within the image-capturing range. The left camera 14 is placed on a left side mirror such that a left side of the self-vehicle is set to be within the image-capturing range. That is, in the present embodiment, an image of an entire region around the self-vehicle can be captured by the four cameras 11 to 14.

As shown in FIG. 1, the display device 20 includes a display portion 21 and an illuminance sensor 22. The display portion 21 is configured, for example, as an indicator that indicates a predetermined mark (e.g., failure indication lamp) and a speed of the self-vehicle, or a display that displays the image specified by the display control portion 10.

The illuminance sensor 22 is arranged toward a side of a driver in the vicinity of the display portion 21, and outputs a signal, which corresponds to brightness in the vicinity of the display portion 21, to the display control portion 10. That is, the illuminance sensor 22 is used for detecting whether light from a light source such as a headlight of a vehicle behind the self-vehicle or the sun is irradiated to the display device 20.

In the present embodiment, as shown in FIG. 2, two display devices 20 are arranged at two places, that is, in front of a driver seat and in front of a passenger seat, in the self-vehicle. Only one display device 20 is shown in FIG. 1.

The navigation device 15 is a commonly-known navigation device, and specifically includes a database of a position (for example, a direction and an altitude) of the sun in accordance with date and time. The navigation device 15 has a function to transmit information about a direction of the self-vehicle and a position of the sun to a requestor in accordance with a request from an external device such as the display control portion 10.

The operation portion 16 is configured, for example, as a touch panel or switches, and functions as an interface to which a passenger in the self-vehicle inputs an instruction or a setting to the display control portion 10.

The display control portion 10 is configured as a commonly-known microcomputer including a CPU, a ROM, a RAM and the like, and performs a predetermined process of the display device 20 in accordance with a program stored in the ROM or a program loaded to the RAM. In this case, signals inputted from the cameras 11 to 14, the navigation device 15, the operation portion 16 and the like are used.

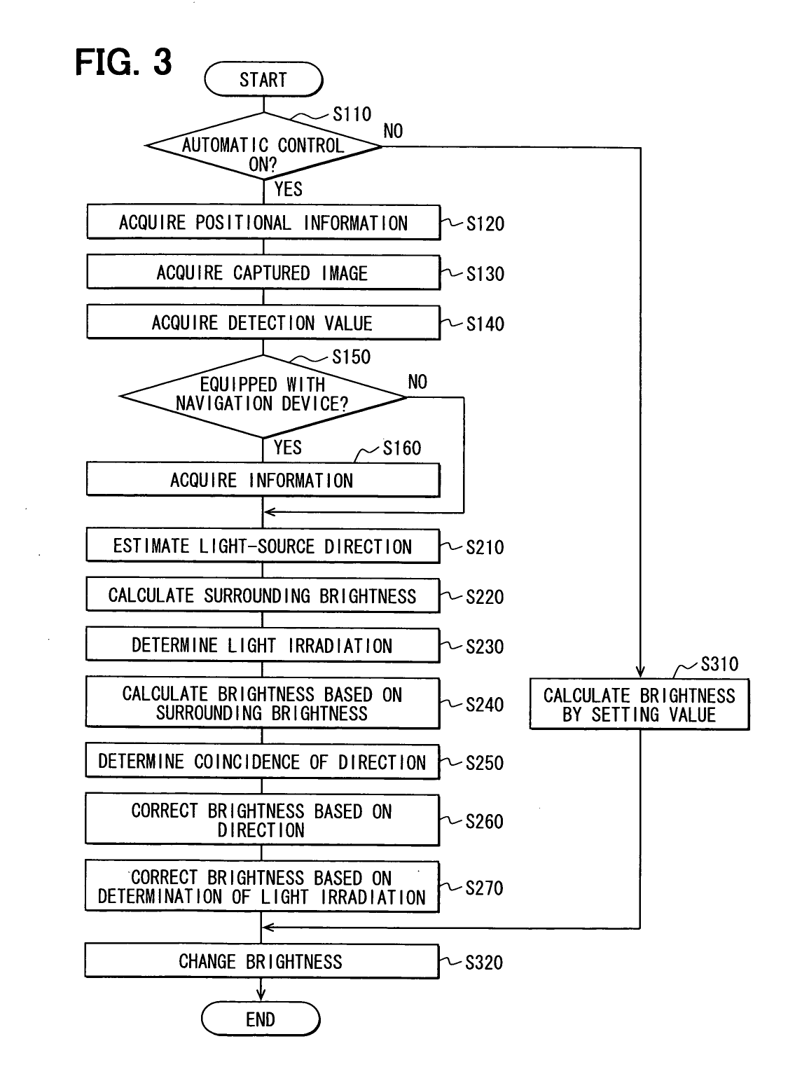

Here, the brightness setting process of processes performed by the display control portion 10 will be described with reference to the flow diagram shown in FIG. 3. The brightness setting process is a process for adjusting a display brightness when the display portion 21 displays an image to a brightness which is easily viewed by the passenger in accordance with the brightness outside the self-vehicle and the position of the light source outside the self-vehicle.

The brightness setting process is started when a power source of the self-vehicle such as an ignition switch (not shown) is switched on, and then, is periodically (for example, every 50 ms) performed. In addition, the brightness setting process is a process when a computer program product stored in a computer readable storage medium of the present invention is executed.

Specifically, in the brightness setting process, as shown in FIG. 3, firstly, it is determined whether the display brightness of the display portion 21 is set to be automatically controlled in S110. In addition, whether the display brightness is set to be automatically controlled is set by the operation portion 16.

When the display brightness is not set to be automatically controlled (NO in S110), a setting value S set by the passenger is acquired, and a brightness corresponding to the setting value S is calculated in S310. The setting value S set by the passenger is set by using a rheostat or the like in advance.

In particular, for example, a brightness setting value I may be set by formula 1.

I=S (formula 1)

If surrounding brightness is low (which is determined by the present time or a brightness sensor (not shown) on a dashboard), the brightness setting value I is set by formula 2.

I=S×K1 (formula 2)

In formula 2, K1 is a darkening constant.

Then, the brightness of the display portion 21 is changed to become the calculated brightness in S320, and the brightness setting process is terminated.

In contrast, when the display brightness is set to be automatically controlled (YES in S110), positional information of the driver in the self-vehicle and the display device 20 is acquired in S120. The information is inputted into the display control portion 10 in advance. Moreover, in the process, a display arrangement direction that indicates an arrangement direction of the display device 20 when viewed from the driver, is specified by using the acquired positional information.

Then, the captured images by the multiple cameras 11 to 14, which captures the region around the self-vehicle, are acquired in S130 (image acquiring means), and a detection signal from the illuminance sensor 22 is acquired in S140 (irradiation acquiring means). The detection signal from the illuminance sensor 22 is a signal which indicates the brightness in the vicinity of the display portion 21. Whether the light from the light source is irradiated to the display device 20 is determined by the display control portion 10 in a process of S230 described below.

In the present embodiment, the above-described determination is performed by using the detection result by the illuminance sensor 22. However, if a in-vehicle camera is placed inside the self-vehicle, the above-described determination may be performed by image processing of a captured image by the in-vehicle camera.

Next, it is determined whether the navigation device 15 is connected to the display control portion 10 in S150. The process is prepared to be capable of being applied to a vehicle, to which the navigation device 15 is not mounted. Since the display control system 1 of the present embodiment includes the navigation device 15, it is determined to YES in S150.

When the navigation device 15 is connected (YES in S150), information about a direction toward which the front face of the self-vehicle turns, a direction of the sun in accordance with date and time, and the weather (sunshine) at the present location of the self-vehicle is acquired from the navigation device 15 in S160. Then, the process proceeds to S210.

When the navigation device 15 is not connected (NO in S150), the process proceeds to S210 promptly. A direction of the light source around the vehicle is estimated in S210 (light-source direction estimating means). In particular, the direction of the light source is estimated by detecting the brightness in each captured image. When a process of S160 is performed, the direction of the light source is estimated in consideration of the direction of the sun with respect to the direction toward which the self-vehicle turns.

An example of the case where the direction of the sun is considered, for example, the direction of the light source estimated by using the captured images and the direction of the sun acquired from the navigation device 15 are added with a predetermined weighting. At this time, the weighting may be changed based on the weather.

Then, based on the captured image by each of the cameras 11 to 14, surrounding brightness B (specifically, brightness of the background of the display portion 21, which is viewed from the side of the driver) is calculated in S220. An average brightness in an entire region (or only a part of the region such as an upper portion) of the captured image by each of the cameras 11 to 14 is calculated and each of the average brightness is added with a predetermined weighting so that the surrounding brightness B is calculated. At this time, the weighting of the average brightness of the captured image by the front camera 11, which captures the direction toward which the driver turns when viewing the display device 20, may be increased.

Then, whether the light from the light source is irradiated to the display device 20 is determined based on the detection result by the illuminance sensor 22, and the determination result is stored in a memory such as the RAM in S230. Subsequently, the brightness (brightness setting value I) corresponding to the surrounding brightness B calculated in a process of S220 is calculated in S240.

In particular, for example, the brightness setting value I may be set by formula 3 with the use of the surrounding brightness B calculated in S220.

I=B×K2 (formula 3)

In formula 3, K2 is a proportional constant for determining the brightness based on the surrounding brightness B. In addition, when the surrounding brightness is low, the brightness setting value I may be set by formula 4.

I=C (formula 4)

In formula 4, C is a constant. Moreover, if the brightness is set finely even when the surrounding brightness is low, the brightness setting value I may be set by formula 5.

I=B×K1 (formula 5)

As described above, K1 is the darkening constant.

Furthermore, it is determined whether the direction of the light source coincides with the display arrangement direction in S250 (direction-coincidence determining means), and the display brightness calculated in a process of S240 is corrected based on whether the directions coincide with each other in S260 (first brightness setting means). In particular, for example, the display brightness of the display device 20 is corrected to be increased, that is, a predetermined number α is added to the brightness setting value I, when the direction of the light source coincides with the display arrangement direction, and the display brightness is not corrected when the direction of the light source does not coincide with the display arrangement direction.

Subsequently, the determination result indicating whether the light from the light source is irradiated to the display device 20 is acquired from the memory such as the RAM, and the display brightness is further corrected based on the determination result in S270 (second brightness setting means). In particular, the display brightness of the display device 20 is corrected to be further increased, that is, a predetermined number β is added to the brightness setting value I (the predetermined number α may be added to the brightness setting value I) when the irradiation detection result indicating that the light from the light source is irradiated to the display device 20 is acquired, and the display brightness is not corrected when the irradiation detection result indicating that the light from the light source is not irradiated to the display device 20 is acquired.

The change amount of the brightness in the first brightness setting means and the change amount of the brightness in the second brightness setting means may be added, or either of them may be applied.

Then, the brightness of the display portion 21 is changed to become the calculated brightness in S320, and the brightness setting process is terminated.

In the display control system 1 as described above in detail, the display control portion 10 estimates the direction of the light source around the self-vehicle, and determines whether the direction of the light source coincides with the display arrangement direction that indicates the arrangement direction of the display device 20 when viewed from the passenger in the self-vehicle, in the brightness setting process. When the direction of the light source coincides with the display arrangement direction, the display control portion 10 sets the brightness of the display device 20 (i.e., the display portion 21) to be increased compared with when the direction of the light source does not coincide with the display arrangement direction.

That is, in the present invention, the direction of the light source, in other words, a direction toward a relatively bright area in the region around the self-vehicle is detected, and the brightness is set to be increased when the direction of the light source coincides with the direction toward which the passenger (specifically, the driver) in the self-vehicle turns when viewing the display device 20.

According to the display control system 1, the brightness of the display device 20 can be set based on the position of the light source which the passenger in the self-vehicle senses relatively bright. Thus, compared with the configuration in which the brightness of the display device 20 is set based on absolute surrounding brightness, the brightness of the display device 20 can be set to better correspond to a characteristic of human eyes. Therefore, the brightness of the display device 20 can be more accurately controlled so that the display device 20 is easily viewed by the passenger in the self-vehicle.

Moreover, in the display control system 1, the entire region around the vehicle is captured by the multiple cameras 11 to 14, and the display control portion 10 acquires the captured images by the cameras 11 to 14. The display control portion 10 estimates the direction of the light source by detecting the brightness in each captured image. Specifically, the direction toward which an image-capturing means (i.e., the cameras 11 to 14) that captures the image with the highest average brightness turns is estimated as the direction of the light source.

According to the display control system 1, the direction of the light source can be estimated by a relatively simple process.

In the display control system 1, the display control portion 10 acquires the irradiation detection result indicating whether the light from the light source is irradiated to the display device 20. When the irradiation detection result indicating that the light from the light source is irradiated to the display device 20 is acquired, the display control portion 10 sets the brightness of the display device 20 to be increased compared with when the irradiation detection result indicating that the light from the light source is not irradiated to the display device 20 is acquired.

According to the display control system 1, in the case where the light from the light source is irradiated to the display device 20 and it is expected to become difficult for the passenger in the vehicle to view the display due to reflected light of the irradiated light, the brightness of the display device 20 can be set to be increased. Therefore, even when the light from the light source is irradiated to the display device 20, the brightness of the display device 20 can be more accurately controlled so that the display device 20 is easily viewed by the passenger in the vehicle.

### Other Embodiments

The embodiments of the present invention are not limited to the above-described embodiment, and various modifications can be made without departing from the spirit and scope of the invention.

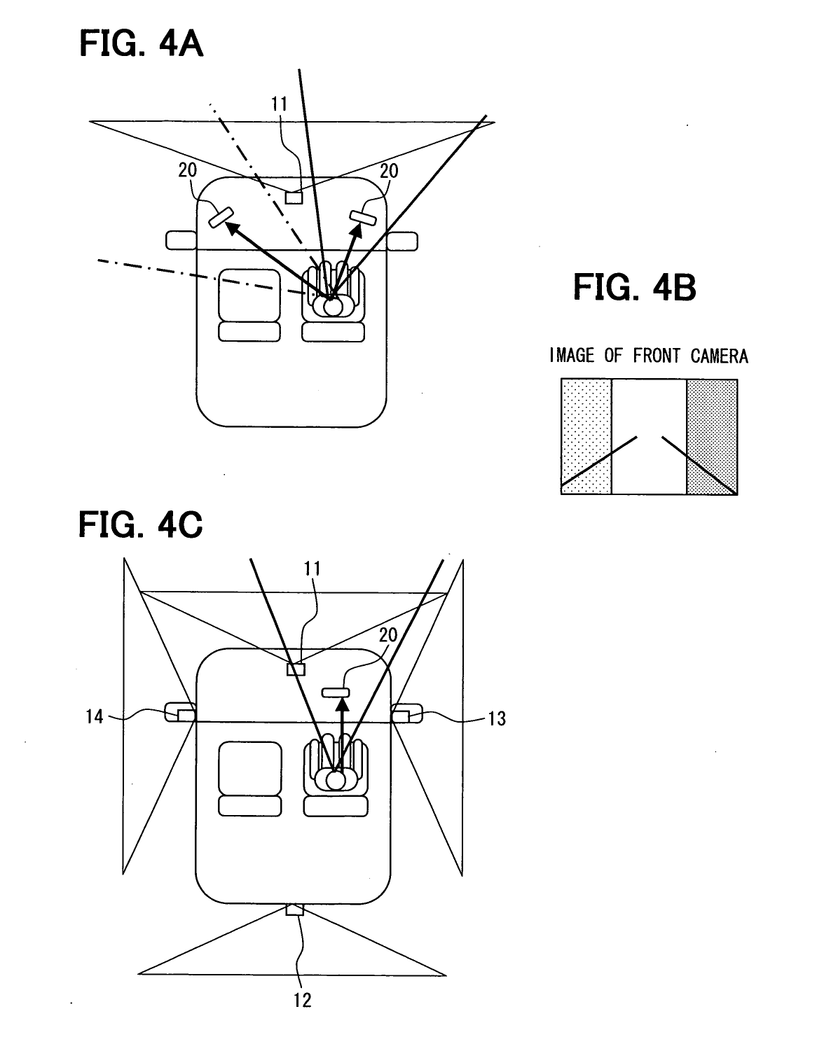

For example, in the above-described embodiment, the position of the light source is estimated by using the multiple cameras 11 to 14. However, as shown in FIG. 4A, as cameras, only the front camera 11 (it is preferable that the front camera 11 is equipped with a wide-angle lens), which captures the display arrangement direction that indicates the arrangement direction of the display device 20 when viewed from the passenger in the self-vehicle, may be arranged. In addition, FIG. 4B shows an image captured by the front camera 11 of FIG. 4A. In this case, the captured image is virtually divided into some regions and the average brightness in each of the divided regions is detected so that the brightest region may be estimated as the position (direction) of the light source. Moreover, in this case, as with the above-described embodiment, the position of the light source may be estimated in view of the position of the sun and the weather, which are specified by the direction of the self-vehicle and date and time.

When the surrounding brightness is specified, the region that coincides with the display arrangement direction in each of the divided regions, which are obtained by virtually dividing the captured image, is extracted with respect to each display device 20, and each of the average brightness of the extracted regions is added with a predetermined weighting. In the case where the multiple cameras 11 to 14 are used as the above-described embodiment, the method for virtually dividing each of the captured images may be applied.

In addition, the direction of the light source may be estimated by the position of the sun and the weather, which are specified by the direction of the self-vehicle and date and time without using the cameras 11 to 14. In the above-described embodiment, the multiple display devices 20 are arranged. However, as shown in FIG. 4B, only one display device 20 may be arranged.

Moreover, in the above-described embodiment, the display brightness is corrected in accordance with the direction of the light source based on the surrounding brightness. B. However, the display brightness may be set in accordance with the direction of the light source without using the surrounding brightness B. In this case, when the brightness setting value I is calculated, for example, a constant D as a fixed value may be used in place of the surrounding brightness B.

According to the above configuration, the similar effect to the above-described embodiment can be obtained.

While the invention has been described, with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A display control device configured to display an image on a display portion mounted to a vehicle, the display control device comprising:
a light-source direction estimating means for estimating a direction of a light source in a region around the vehicle;
a direction-coincidence determining means for determining whether the direction of the light source coincides with a display arrangement direction, which indicates an arrangement direction of the display portion as viewed from a passenger in the vehicle; and
a first brightness setting means for setting a brightness of the display portion to be increased when the direction of the light source coincides with the display arrangement direction, compared with when the direction of the light source does not coincide with the display arrangement direction.

2. The display control device according to claim 1, further comprising
an image acquiring means for acquiring a plurality of captured images by a plurality of image-capturing means which capture the region around the vehicle, wherein
the light-source direction estimating means is configured to estimate the direction of the light source by detecting a brightness in each of the captured images.

3. The display control device according to claim 1, further comprising:
an irradiation acquiring means for acquiring an irradiation detection result indicating whether light from the light source is irradiated to the display portion; and
a second brightness setting means for setting the brightness of the display portion to be increased when the irradiation detection result indicating that the light from the light source is irradiated to the display portion is acquired, compared with when the irradiation detection result indicating that the light from the light source is not irradiated to the display portion is acquired.

4. A display control method for displaying an image on a display portion mounted to a vehicle, the method comprising:
estimating a direction of a light source in a region around the vehicle;
determining whether the direction of the light source coincides with a display arrangement direction, which indicates an arrangement direction of the display portion as viewed from a passenger in the vehicle; and
setting a brightness of the display portion to be increased when the direction of the light source coincides with the display arrangement direction, compared with when the direction of the light source does not coincide with the display arrangement direction.

5. The display control method according to claim 4, further comprising
acquiring a plurality of captured images by a plurality of image-capturing means which capture the region around the vehicle, wherein
the direction of the light source is estimated by detecting a brightness in each of the captured images.

6. The display control method according to claim 4, further comprising:
acquiring an irradiation detection result indicating whether light from the light source is irradiated to the display portion; and
setting the brightness of the display portion to be increased when the irradiation detection result indicating that the light from the light source is irradiated to the display portion is acquired, compared with when the irradiation detection result indicating that the light from the light source is not irradiated to the display portion is acquired.

7. A computer program product stored in a computer readable storage medium, comprising instructions that cause a computer to perform the method in claim 4.
